(19) United States
(12) Patent Application Publication
(10) Pub. No.: US 2009/0083481 A1
(43) Pub. Date: Mar. 26, 2009

(54) METHOD FOR MAPPING WRITE OPERATION OF RAID DEVICE

(75) Inventors: Jian-Fei WANG, Tianjin (CN); Tom CHEN, Taipei (TW); Win-Harn LIU, Taipei (TW)

Correspondence Address: Workman Nydegger;1000 Eagle Gate Tower, 60 East South Temple, Salt Lake City, UT, 84111, US

(73) Assignee: INVENTEC CORPRATION, Taipei (TW)

(21) Appl. No.: 11/858,212

(22) Filed: Sep. 20, 2007

(51) Int. Cl. G06F 12/06

(52) U.S. Cl. 711/114; 711/E12.078

(57) ABSTRACT

A method for mapping a write operation of an RAID device, includes flowing steps, initiating a mirroring device built in each member disk of the RAID device; activating a kernel thread, for monitoring the operation state of the RAID device, and recording current usage information; and if an incorrect write operation occurs to a member disk of the RAID device, storing the data of the incorrect write operation into a mirroring device of another member disk of the RAID device through the kernel thread. The method ensures the integrity and safety of the data stored in the RAID device and prevents the data from being lost when the member disk of the RAID device is replaced or severely damaged.

### BACKGROUND OF THE INVENTION

1. Field of the Invention

The present invention relates to a disk management method, and more particularly to a method for mapping a write operation of a redundant arrays of inexpensive disks (RAID) device.

2. Related Art

The redundant arrays of inexpensive disks (RAID) device combines N disks into a virtual single disk of a large capacity through an RAID controller (hardware or software), so as to provide a large storage capacity, a high accessing speed, or a data redundant function. According to different organizing manner of the data, the RAID device includes linear RAID, RAID-0, RAID-1, RAID-5, RAID-6, etc. The RAID-1, RAID-5, RAID-6 and RAID-10, RAID-50 extended there-from all provide a data redundant function.

The data redundant function means that: since RAID device stores the redundant data, if one or more disks in the RAID device are damaged, the data can be obtained completely from the RAID device through a certain process. The redundant data are stored in the RAID device through two manners, namely, a mirroring manner and a checking manner. The mirroring manner refers that the data of one disk in the RAID device is stored in the other disks in a mirroring manner, such as RAID-1. The checking manner refers that a part of the disk in the RAID device stores the checking data after being calculated, so as to achieve the data redundant effect, such as RAID-5.

Currently, a great number of storage devices can ensure the integrity and safety of data thereof through the RAID device. The RAID device is built through the disks, thus having a high requirement on the disks. If a problematic sector exists in the disk, the RAID device considers the disk to be damaged, so as to get into a degrading or damaging mode, such that the RAID device cannot be used any more. It is a great loss for the user that the whole RAID device cannot be used due to the damage of merely one or a few sectors of the disk. However, the single disk fault-tolerance mechanism in the conventional art cannot come into effect in the RAID device capable of performing a rebuild operation, which can merely protect the data of a single disk, instead of ensuring the integrity of the whole data in the RAID device.

### SUMMARY OF THE INVENTION

In order to solve the above problems and defects in the conventional art, the present invention is directed to a method for mapping a write operation of an RAID device.

The method for mapping a write operation of an RAID device provided in the present invention includes the following steps:

a) initiating a mirroring device built in each member disk of the RAID device;

b) activating a kernel thread for monitoring an operation state of the RAID device, and recording current usage information; and

c) if an incorrect write operation occurs to a member disk of the RAID device, storing data of the incorrect write operation into a mirroring device of another member disk of the RAID device through the kernel thread.

The method further includes: reading the usage information of the kernel thread; and reading data of the mirroring device according to the usage information of the kernel thread.

The mirroring device further includes: a structure information unit, for storing basic information of the mirroring device; and a plurality of data information units, for storing disk information and data corresponding to the incorrect write operation.

The current usage information includes: an information unit, for storing basic information of the mirroring device corresponding to the incorrect write operation; and a data unit, for storing data of sectors of a member disk corresponding to the incorrect write operation.

The mirroring device is built in a manner of RAID-1.

The ratio of a disk space of the mirroring device to that of each member disk of the RAID device is a predetermined value.

Based on the above, the present invention has the following advantages.

(1) The method of the present invention ensures the integrity and safety of the data stored in the RAID device and prevents the data from being lost when the member disk of the RAID device is replaced or severely damaged;

(2) The method of the present invention ensures the robustness of the RAID device, and the data of the whole RAID device is not affected by the damage of a single member disk of the RAID device; and

(3) It is convenient for the user to operate, and the above operations are executed in the background, which brings no influences on the user's operation.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a flow chart of a process for initiating a mirroring device;

FIG. 2 is a block diagram of a mirroring device structure;

FIG. 3 is a flow chart of a mapping operation;

FIG. 4 is a flow chart of a process for reading data; and

FIG. 5 is a flow chart of a process for recovering mapping data when an RAID device is rebuilt.

### DETAILED DESCRIPTION OF THE INVENTION

In order to make the aforementioned and other objectives, features and advantages of the present invention be more comprehensible, preferred embodiments accompanied with figures are described in detail below.

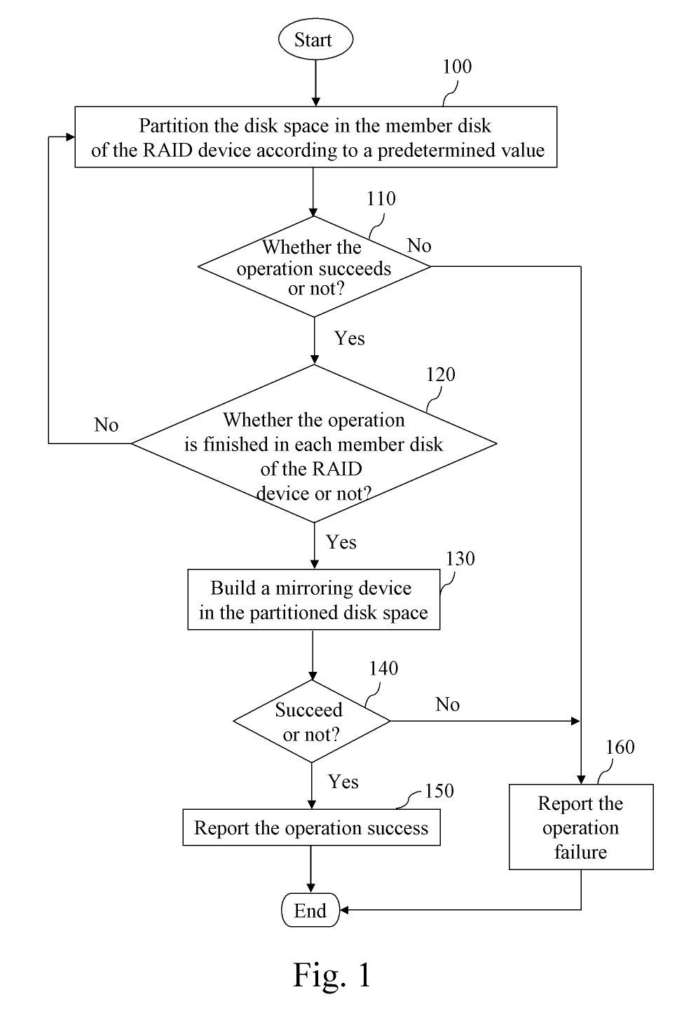

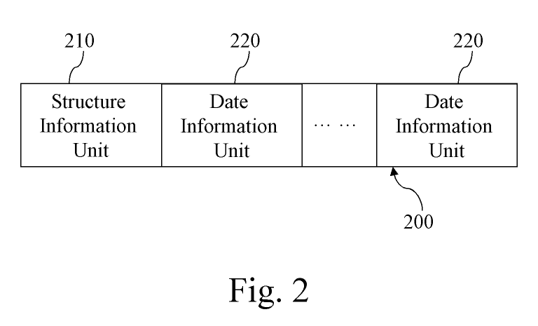

FIGS. 1 and 2 show a process of initiating a mirroring device 200 and a structure of the initiated mirroring device 200 according to the present invention. The mirroring device 200 is built in each member disk of the RAID device in a manner of RAID-1. As shown in figures, first of all, a disk space is partitioned for the mirroring device 200 in the member disk of the RAID device according to the predetermined value (Step 100). The predetermined value is preferably 5%. During the usage, if the data to be mapped exceeds the storage capacity of the mirroring device 200, the system informs the user that the mirroring device 200 cannot be used normally, but the data-reading operation still can be executed. It is determined whether the operation of partitioning the disk space succeeds or not (Step 110), if not, the system reports the operation failure (Step 160). In the present invention, the system may inform the user about the success or failure of each operation through using sound, character, image, or a combination thereof. If the operation succeeds, it is further determined whether the operation is finished in each member disk of the RAID device or not (Step 120). If the operation is not finished yet, it returns to Step 100. If the operation is finished, the mirroring device 200 is built in the partitioned disk space (Step 130), and it is determined whether the mirroring device 200 is successfully built or not (Step 140), if not, the system reports the operation failure (Step 160); if yes, the system reports the operation success (Step 150). Therefore, the initiation of the mirroring device 200 is finished, and the initiated mirroring device 200 includes a structure information unit 210 and a plurality of data information units 220. The structure information unit 210 is used for storing the information about the size of the mirroring device, the number of the partitioned sectors, and the number of the used sectors, and the data information unit 220 is used for storing the information about the label of the mapped member disk, position of the mapped sector, and operation data, etc. Each data information unit 220 is used for storing the data of a sector of the mapped member disk, and saving the retrieval information. After each mapping operation is finished, the information of the structure information unit 210 is modified, and the number of the partitioned sectors is calculated from the following equation: the number of the partitioned sectors=(the size of the mirroring device−the size of the structure information unit)/(the information of the mapped member disk and sector+the size of the mapped sector).

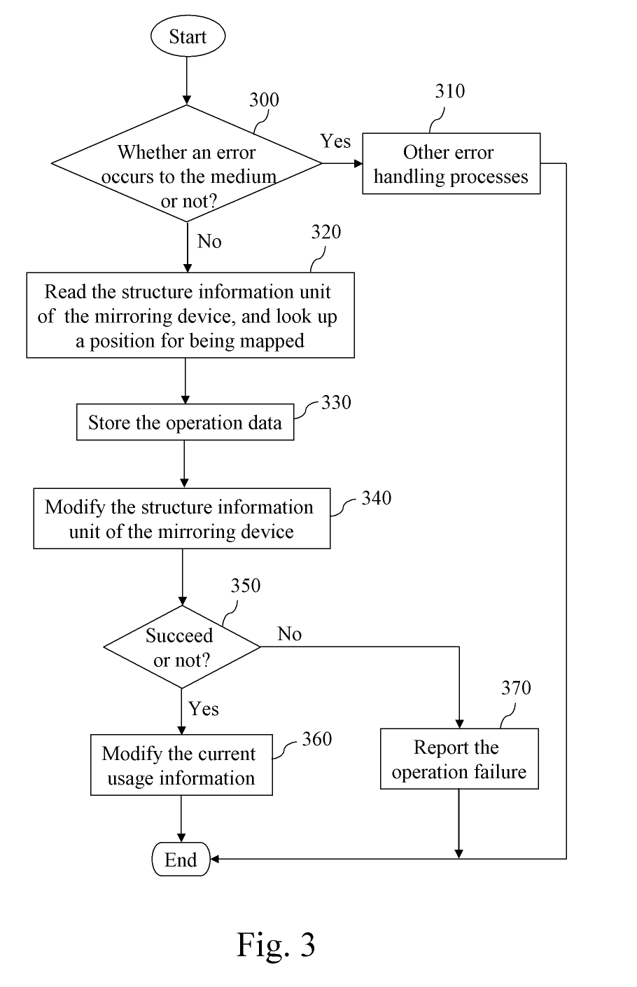

FIG. 3 is a flow chart of a mapping operation. After the mirroring device 200 is initiated, the kernel thread is activated to monitor the operation state of the RAID device, and the current usage information of the mapping operation is stored in the memory of the RAID device through the kernel thread. The current usage information includes: an information unit, for storing the basic information of the mirroring device corresponding to the incorrect write operation; and a data unit, for storing the data of sector of the member disk corresponding to the incorrect write operation. If an incorrect write operation is detected, it is determined whether an error occurs to the medium of the RAID device or not (Step 300). If the error is caused by the storage medium of the RAID device, other error handling operations are executed (Step 310). Otherwise, the information of the structure information unit 210 of the mirroring device 200 is read, so as to find out the data information unit 220 capable of being mapped (Step 320). The label of the member disk, position of the sector, and operation data corresponding to the incorrect write operation are stored into the data information unit 220 (Step 330). After the storage, the information of the structure information unit 210 of the mirroring device 200, such as the number of the used sectors, is modified (Step 340). Then, it is determined whether the operation is successful or not (Step 350), if yes, the current usage information stored in the memory is modified through the kernel thread (Step 360), otherwise, the system reports the operation failure (Step 370).

In view of the above, the present invention ensures the integrity and safety of the data stored in the RAID device and prevents the data from being lost when the member disk of the RAID device is replaced or severely damaged. Meanwhile, the robustness of the RAID device is ensured, and the data of the whole RAID device is not affected by the damage of a single member disk of the RAID device. The above operations are run in the background, which causes no influences on the operations of the user.

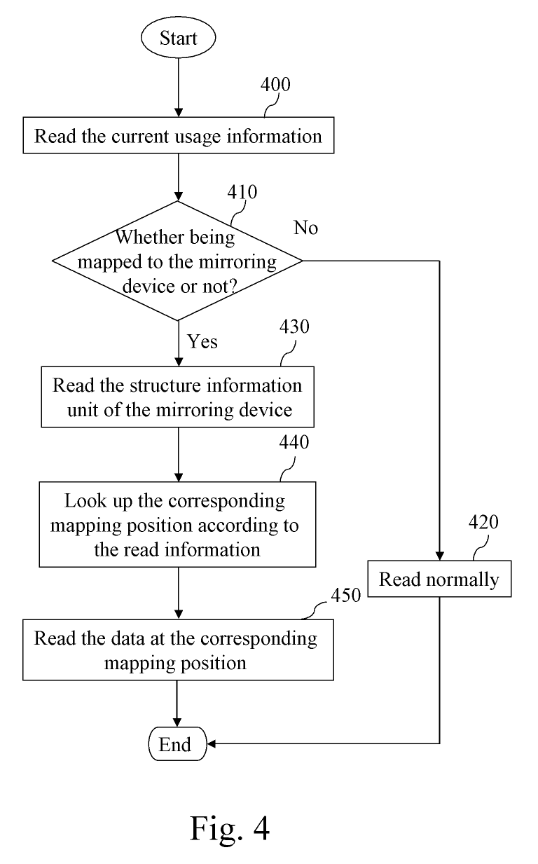

FIG. 4 is a flow chart of a process for reading data. When the data of the RAID device is read, the current usage information stored in the memory is first read through the kernel thread (Step 400). It is determined whether the data corresponding to the read operation is mapped to the mirroring device 200 or not according to the read current usage information (Step 410), if not, a normal read operation is executed (Step 420), otherwise, the structure information unit 210 of the mirroring device 200 is read (Step 430). According to the read information, the data information unit 220 corresponding to the read operation is looked up through the information such as the label of the member disk and position of the sector (Step 440). The data stored in the data information unit 220 is read, so as to complete the data-reading operation of the RAID device (Step 450).

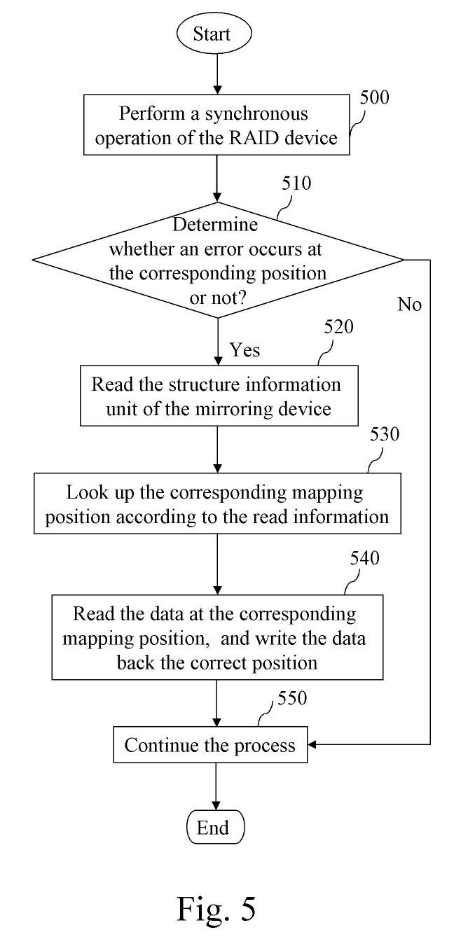

FIG. 5 is a flow chart of a process for recovering mapping data when an RAID device is rebuilt. When the damaged member disk in the RAID device is replaced, and the RAID device can be rebuilt, the data of the mirroring device 200 can be recovered to the corresponding member disk in the RAID device through the rebuilding mechanism. First of all, a synchronous operation of the RAID device is executed (Step 500). The current usage information stored in the memory is read through the kernel thread, and then, it is determined whether an error occurs at the current operation position or not (Step 510). If not, the next process is performed (Step 550), otherwise, the structure information unit 210 of the mirroring device 200 is read according to the current usage information (Step 520). The corresponding data information unit 220 is looked up according to the read information (Step 530). The data stored in the data information unit 220 is read and then written back to the current operation position (Step 540). Then, the next process is performed (Step 550). Based on the above, the safety of data is ensured, and meanwhile, the data of an incorrect operation can be written back to a correct position.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for mapping a write operation of a redundant array of inexpensive disk (RAID) device, comprising:
a) initiating a mirroring device built in each member disk of the RAID device;
b) activating a kernel thread for monitoring an operation state of the RAID device, and recording a current usage information; and
c) if an incorrect write operation occurs to a member disk of the RAID device, storing the data of the incorrect write operation into a mirroring device of another member disk of the RAID device through the kernel thread.

2. The method for mapping the write operation of the RAID device as claimed in claim 1, further comprising:
reading the usage information; and
reading data of the mirroring device, according to the usage information.

3. The method for mapping the write operation of the RAID device as claimed in claim 1, wherein the mirroring device further comprises:
a structure information unit, for storing basic information of the mirroring device; and
a plurality of data information unit, for storing disk information and data corresponding to the incorrect write operation.

4. The method for mapping the write operation of the RAID device as claimed in claim 1, wherein the current usage information comprises:
an information unit, for storing basic information of the mirroring device corresponding to the incorrect write operation; and
a data unit, for storing data of sectors for a member disk corresponding to the incorrect write operation.

5. The method for mapping the write operation of the RAID device as claimed in claim 1, wherein the mirroring device is built in a manner of RAID-1.

6. The method for mapping the write operation of the RAID device as claimed in claim 1, wherein the ratio of a disk space of the mirroring device to that of each member disk of the RAID device is a predetermined value.

7. The method for mapping the write operation of the RAID device as claimed in claim 6, wherein the predetermined value is 5%.
